(19) United States
(12) Patent Application Publication
(10) Pub. No.: US 2014/0100062 A1
(43) Pub. Date: Apr. 10, 2014

(54) SPORTS CONTEST CELEBRATION DISPLAY

(71) Applicant: Calvin L. Terrell, Jonesboro, GA (US)

(72) Inventors: Calvin L. Terrell, Jonsboro, GA (US); John T. Reeves, Jr., Fayettville, GA (US)

(21) Appl. No.: 14/046,642

(22) Filed: Oct. 4, 2013

Related U.S. Application Data
(60) Provisional application No. 61/709,511, filed on Oct. 4, 2012.

(51) Int. Cl. A63B 71/06; F21V 33/00; A63B 63/00

(52) U.S. Cl. CPC A63B 71/0619; A63B 63/008; A63B 63/004; F21V 33/008
USPC 473/477; 473/476; 473/478

(57) ABSTRACT

A sports goal is configured to have display lighting and fireworks. This goal post has a light emitting device, a laser lighting emitting device, and remote transmitter for controlling the light emitting device and a sound emitting device. The goal post may come in a variety of sign display appearances.

### PRIORITY CLAIM

Applicant claims the benefit of U.S. Provisional Patent Application No. 61/709,511, filed in the U.S. Patent & Trademark Office on Oct. 4, 2012.

### FIELD OF THE INVENTION

This invention pertains to visual presentations that may be used for celebrating achievements occurred at public events such as sporting events, including digital signage, LED lighting, laser lighting, fireworks and sound circuitry incorporated with equipment at physical sports venues, such as football goal posts, goals for soccer and lacrosse, and baseball foul post.

### BACKGROUND OF THE INVENTION

In sporting events, particularly outdoor events and large stadium events, the audience usually celebrates the scoring with enthusiastic loud vocal cheering, band music, and other noise that is appropriate. In general, when a stadium or other venue is crowded with sports fans the celebration may be very enthusiastic, loud and supplemented by other noises.

It would be desirable to associate the vocal cheering with visual displays of celebration to complement the vocal cheering to enhance the celebration and lift the enthusiasm of the players and fans.

### SUMMARY OF THE INVENTION

The invention disclosed herein concerns a means for providing visual images, including images for celebrating scoring at sporting events, with the visual images incorporated with the structure of the equipment used at the sporting events.

This invention concerns a football goal post and other sports structures that provide more entertainment for sports fans during the games played on the playing field. For example, the football goal post structures of this disclosure are configured to have the appearance of the conventional goal post structures but further to include a visual entertainment system provided for viewers with a light emitting display device that may be activated when, for example, a team makes a score in the game.

The goal structures may include a series of light emitters that can be illuminated and take the shapes of the goal, or may be in the form of special colors, written message, and the goal structures may include a sound emitting device.

The goal structure may include body portions defining an internal cavities, translucent panels separating the internal cavity from outside the body portions and a light emitter in the internal cavities, all positioned for transmitting light through the translucent panel to outside said goal.

The goal structure may be an H-shaped football goal with a pair of spaced upright bars and a horizontal bar spanning the space between the pair of spaced upright bars.

Also, the goal may be a soccer goal and other goals and items such as foul poles for baseball, at positions that are safe for use and are visible to the majority of the people in attendance at the sporting event.

The structure may define an internal cavity, a translucent panel separating the internal cavity from outside the body, and a light emitter in the internal cavity positioned for transmitting light through said translucent panel to outside the goal, and a power source for actuating the light emitter and illuminating the translucent panel.

More particularly the equipment used for providing the visual celebration may be incorporated with goals used in sporting events, such a football goals, soccer goals and baseball foul poles. The visual images may be lights that are incorporated on or into the structure of the goals so that the goals appear to light up. Also, the visual images may be “fireworks” emitted from the equipment, and the light emitted may be directed to an external object, such as to illuminate the net of a soccer goal.

### BRIEF DESCRIPTION OF DRAWINGS

The invention will now be described in a greater detail in the following by way of example only and with reference to the attached drawing, in which

FIG. 1 is a front view of a sports goal, such as a football goal that includes the invention disclosed herein.

FIG. 2 is a front view of a baseball foul pole.

FIG. 3 is a front view of a soccer goal, including the net.

FIG. 4 is a perspective view of an upper end of an upright side bar of the football goal post of FIG. 1.

FIG. 5 is a perspective view, similar to FIG. 4, but showing a modified structure of an upper end of an upright side bar of the football goal post of FIG. 1.

FIG. 6 is a perspective view, similar to FIGS. 4 and 5, but showing a modified structure of an upper end of an upright side bar of the football goal post of FIG. 1.

FIG. 7 is a schematic diagram of an electrical circuit that can be used to operate the lights, fireworks and other accessories of the sports goals.

### DETAILED DESCRIPTION OF THE INVENTION

Referring now in more detail to the drawing, FIG. 1 illustrates a football goal 10 of conventional size and shape that includes the substantially upright support post 12 that is secured to the ground, a horizontal support bar 13 mounted intermediate its ends to the upper end of the vertical support post 12, and a pair of upright side bars 14 and 15 mounted at their lower ends to the ends of the horizontal support bar. Minor variations in shape may be made to the support post and other components of the goal as may be required by the rules of the game.

FIG. 1 is a front view of the goal, and the horizontal support bar 13 and upright side bars 14 and 15 have display panels 17, 18 and 19, respectively that can display illuminated messages formed by light emitting diodes or other light emitting devices. Typically, the name of the home team will be illuminated in the display panels, but the messages may be changed as desired.

FIG. 2 illustrates a foul ball post 20 of the type used at baseball fields. The foul ball post is a vertical post mounted in the ground or in another support structure. In this embodiment light emitting devices are positioned in display panel 21 for illuminated messages, such as the name of the home team, but the messages may be generated electronically and may be changed to, for example, display the words “FAIR” or “FOUL” as described hereinafter. The display panel may face in any direction, but is expected to face the playing field where the fans are principally located.

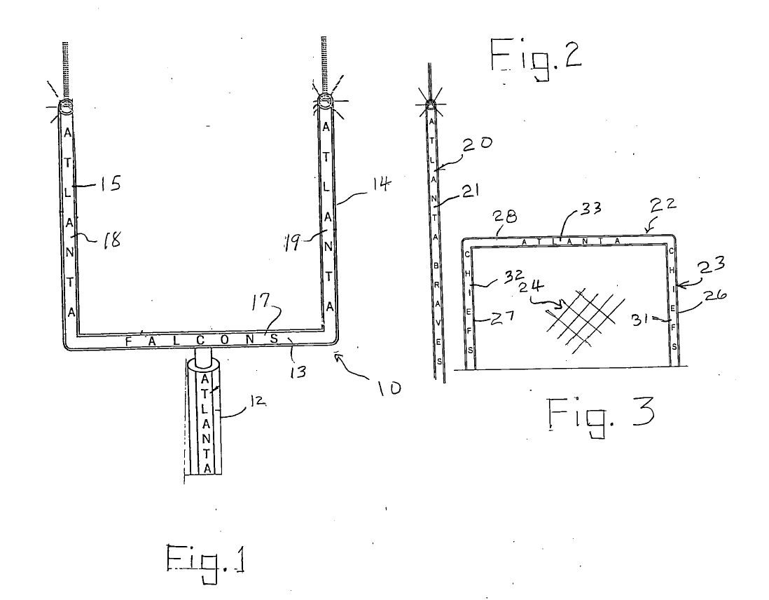

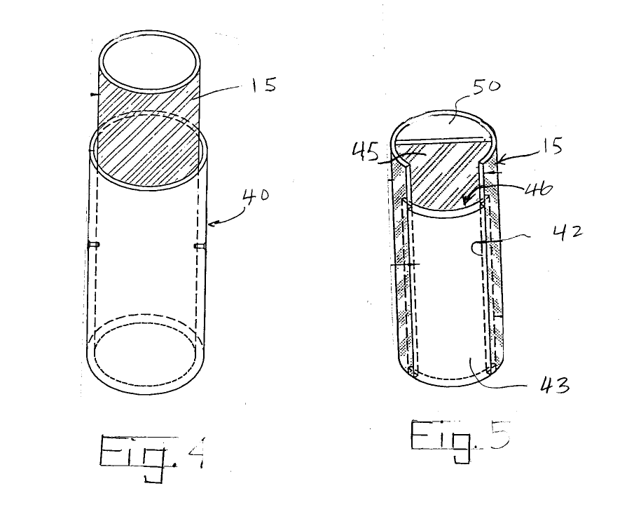

FIG. 3 is the front view of a soccer goal 22 that includes an inverted U-shaped goal post 23 and a net 24 that is supported by the goal post. The goal post includes side legs 26 and 27 and horizontal cross leg 28 supported by the upper ends of the side legs. The net 24 is attached to the side and cross legs and extends behind them in the usual way for sporting games, such as soccer and lacrosse.

Display panels 31, 32 and 33 are supported in any or all of the legs 26-28 and include light emitting devices positioned in any or all of the display panels for providing illuminated messages, such as the name of the home team or the word “GOAL”. The messages may be generated electronically and may be changed as described hereinafter.

Visual light emitting equipment is formed in display panels 30 so that they face forward toward the playing field. Also, the rear of the U-shaped goal post may have display panels (not shown) similar to the display panels 25 but that face rearwardly for the purpose of illuminating the net 24 (not shown) and for forming messages.

FIGS. 4-6 illustrate support structures for the light emitters and other devices used in the sports goals such as the sports goals of FIGS. 1-3.

FIG. 4 illustrates the upper open end of a side bar 15 of a football goal 10 as shown in FIG. 1. In this portion of the side bar the side bar is formed with openings (not shown) for transmission of light from inside to the outside of the side bar.

A transparent or transluscent tubular sleeve 40 extends about the side bar and covers the openings of the side bar. The tubular sleeve 40 is telescopically fitted to the upper end of the side bar and it is transparent or translucent for the passage of light and may be tinted for the transmission of colored light, and defines an internal cavity for receiving light emitting devices.

FIG. 5 illustrates a modified form of the tubular sleeve of FIG. 4. A slot 42 is formed in the side bar 15 of the goal post, and a transparent support plate 43 fits between the edges of the slot and helps to maintain the shape of the side bar. A partition plate 45 is mounted in the slotted portion of the side bar and forms with the support plate 43 a front space or “cavity” 46 between the support plate 43 bar and the partition plate 45 at the front side of the side bar for receiving the light emitting devices. The partition plate 45 also forms a cavity 50 with the facing portion of the side bar 15 and fireworks may be positioned in the cavity.

FIG. 6 is a modified side bar 15 of the goal post. It includes slot 42, support plate 43. partition plate 45, and a multiple loaded fireworks launcher 52 of conventional design.

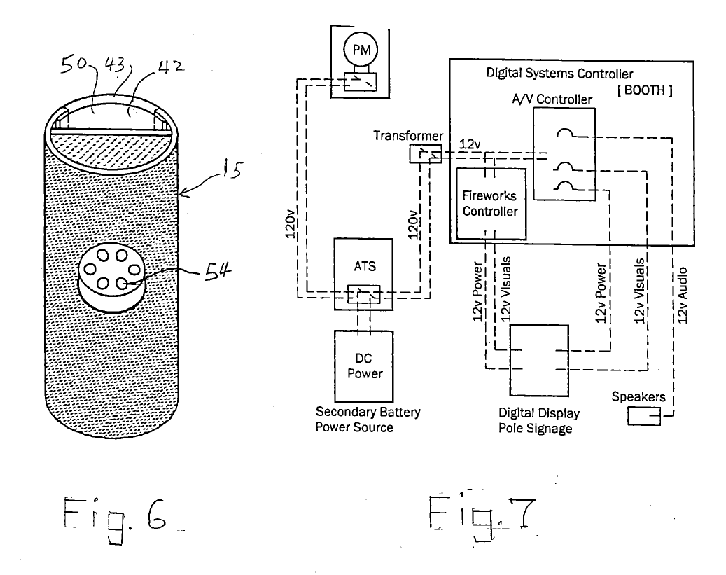

FIG. 7 is a schematic illustration of a control circuit for controlling the visual display and fireworks described above, with nomenclature applied to the diagram.

The sports goals as described herein may also include sound emitting devices for broadcasting sounds to adjacent spaces where sports fans may be located.

The light emitting device may be in various forms, such as a laser light emitting device, and remote transmitter for controlling the light emitting device is used to control the device. The goal post may come in a variety of sign display appearances.

The disclosures herein provide detailed embodiment operation of the present invention, however the disclosed embodiment is merely in various and alternative forms. Therefore, there is no intent that specific structural and functional details should be limiting but rather the intention is to provide a basis for the claims and as a representative basis for teaching on skilled in the art to make and use the present invention.

1. A goal for a sporting event,
said goal including a body portion defining an internal cavity,
a translucent panel separating the internal cavity from outside the body,
a light emitter in said internal cavity positioned for transmitting light through said translucent panel to outside said goal, and
a power source for actuating the light emitter and illuminating the translucent panel.

2. The goal of claim 1, wherein said goal comprises an H-shaped football goal with a pair of spaced upright bars and a horizontal bar spanning the space between the pair of spaced upright bars.

3. The goal of claim 2, wherein said internal cavity of said H-shaped football goal comprises an internal cavity, translucent panel and light emitter positioned in each of the upright bars of the football goal.

4. The goal of claim 2, wherein said internal cavity of said H-shaped football goal comprises an internal cavity, translucent panel and light emitter in the horizontal bar of said H-shaped football goal.

5. The goal of claim 2, wherein said internal cavity of said H-shaped football goal comprises an internal cavity in all of said upright bars and said horizontal bar.

6. The goal of claim 1, wherein
said goal comprises an inverted U-shaped soccer goal, having a pair of upstanding side bars and a cross bar joined at the upper ends of said side bars,
a net connected to said side bars and to said cross bar, and
wherein said internal cavity, translucent panel and light emitter are positioned for illuminating said net.

7. A goal for a sporting event,
said goal formed in the shape of a sporting goal and including a body portion,
light emitters spaced about on the body portion of said goal,
said light emitters configured to form different shaped light patterns to provide a message to the persons within visual distance of the goal.

8. The goal of claim 7, wherein said goal includes a plurality of internal cavities, a translucent panel and said light emitter positioned in said internal cavities.
